(19) United States
(12) Patent Application Publication
(10) Pub. No.: US 2019/0221226 A1
(43) Pub. Date: Jul. 18, 2019

(54) ELECTRONIC APPARATUS AND ECHO CANCELLATION METHOD APPLIED TO ELECTRONIC APPARATUS

(71) Applicant: MEDIATEK INC., Hsin-Chu (TW)

(72) Inventor: FuJun ZHU, Shenzhen (CN)

(21) Appl. No.: 16/247,785

(22) Filed: Jan. 15, 2019

(30) Foreign Application Priority Data
Jan. 18, 2018 (CN) 201810051565.0

(51) Int. Cl. G10L 21/0216; H04R 3/02

(52) U.S. Cl. CPC G10L 21/0216; G10L 2021/02082; H04R 3/02

(57) ABSTRACT

An electronic apparatus and an echo cancellation method applied to the electronic apparatus are provided. The electronic apparatus includes an audio input device and an audio output device. The method includes: outputting audio output data to the audio output device, wherein the audio output data is read to a memory of the electronic apparatus to serve as echo reference data before being outputted to the audio output device; acquiring input audio by using the audio input device, and converting the input audio to audio input data; and performing echo cancellation on the audio input data according to the echo reference data to acquire echo cancelled audio input data. With the above method, the present invention does not occupy an input interface of an audio input device before echo cancellation is performed and reduces echo cancellation costs of the electronic apparatus.

This application claims the benefit of China application Serial No. 201810051565.0, filed Jan. 18, 2018, the subject matter of which is incorporated herein by reference.

### BACKGROUND OF THE INVENTION

### Field of the Invention

The invention relates to the technical field of sound collection, and more particularly to an electronic apparatus and an echo cancellation method applied to the electronic apparatus.

### Description of the Related Art

In a conventional electronic apparatus such as a smart phone and a television with a microphone has functions of sound collection and replay. The electronic apparatus collects a user sound and plays the user sound through a speaker. However, in many application scenarios, an electronic apparatus generates acoustic echo when the electronic apparatus plays audio, which severely degrades user experience.

To eliminate acoustic echo, a sound outputted by a speaker or corresponding audio data needs to be collected. In the prior art, during such sound collection, a conventional electronic apparatus frequently includes a lead wire from an output analog signal terminal to an input terminal of the electronic apparatus, or a signal collected at an output terminal of the speaker needs to be fed back to the input terminal of the speaker of the electronic apparatus.

However, it is discovered during extended research and development that, the two collection methods above both need the collaboration of additional hardware devices and be supported by a hardware path and an electronic apparatus interface, resulting in high costs. Further, at least one interface of the electronic apparatus is occupied. Consequently, subsequent function expansion and development are affected.

### SUMMARY OF THE INVENTION

It is a primary technical issue of the present invention to provide an electronic apparatus and an echo cancellation method applied to the electronic apparatus, which do not occupy an input interface of an audio input device when echo cancellation is performed, and are capable of reducing echo cancellation costs of the electronic apparatus.

To solve the above technical issue, an echo cancellation method applied to an electronic apparatus is provided according to a technical solution of the present invention. The electronic apparatus includes an audio input device and an audio output device. The method includes: outputting audio output data to the audio output device, wherein the audio output data is read to a memory of the electronic apparatus to serve as echo reference data before being outputted to the audio output device; acquiring input audio by using the audio input device, and converting the input audio to audio input data; and performing echo cancellation on the audio input data according to the echo reference data to acquire echo cancelled audio input data.

To solve the above technical issue, an electronic apparatus is provided according to another technical solution of the present invention. The electronic apparatus includes an audio input device, an audio output device, an output unit, an input unit, an echo cancellation unit, a processor, a storage device and a memory. The storage device stores an echo cancellation program therein. When the echo cancellation program is executed by the processor, the processor performs steps of: controlling the output unit to output audio output data to the audio output device, wherein the processor reads the audio data to the memory and stores the same to serve as echo reference data before the audio output data is outputted to the audio output device; controlling the audio input device to acquire input audio, and converting the input audio to audio input data; and controlling the echo cancellation unit to perform echo cancellation on the audio input data according to the echo reference data to acquire echo cancelled audio input data, and transmitting the echo cancelled audio input data to the input unit for subsequent processing.

The present invention provides the following effects. Different from the prior art, the electronic apparatus of the present invention includes an audio input device and an audio output device, and the echo cancellation method applied to the electronic apparatus includes: outputting audio output data to the audio output device, wherein the audio output data is read to the memory of the electronic apparatus to serve as echo reference data before being outputted to the audio output device; acquiring input audio by using the audio input device, and converting the input audio to audio input data; and performing echo cancellation on the audio input data according to the echo reference data to acquire echo cancelled audio input data. With the above method, when the electronic apparatus of the present invention performs echo cancellation, the audio input data is read by means of software to the memory of the electronic apparatus to serve as echo reference data, such that no additional hardware devices is required and an input interface of the electronic device is not occupied, thereby preventing negative influences on subsequent function expansion of the electronic apparatus as well as reducing echo cancellation costs.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a principle of acoustic echo generated by a communication apparatus;

FIG. 2 is a schematic diagram of a principle of acoustic echo generated by a television having a microphone;

FIG. 3 is a flowchart of an echo cancellation method applied to an electronic apparatus according to an embodiment of the present invention;

FIG. 4 is a flowchart of an echo cancellation method applied to an electronic apparatus according to another embodiment of the present invention;

FIG. 5 is a structural schematic diagram of an electronic apparatus according to an embodiment of the present invention;

FIG. 6 is a flowchart of steps performed by a processor 16 in an electronic apparatus according to an embodiment of the present invention;

FIG. 7 is a structural schematic diagram of an electronic apparatus according to another embodiment of the present invention;

FIG. 8 is a structural schematic diagram of an audio processing circuit 131 in an electronic apparatus according to an embodiment of the present invention; and

FIG. 9 is a structural schematic diagram of an apparatus having a storage function according to an embodiment of the present invention.

### DETAILED DESCRIPTION OF THE INVENTION

Related details of the prior art are introduced briefly before the description of the embodiments of the present invention are given below.

Echo is essentially a sound of an individual or object transmitted back to the individual or object after a period of delay. From the perspective of reasons generating communication echo, echo can be categorized into acoustic echo and line echo. Acoustic echo is caused by a sound of a speaker fed back to a microphone in a communication or conference application.

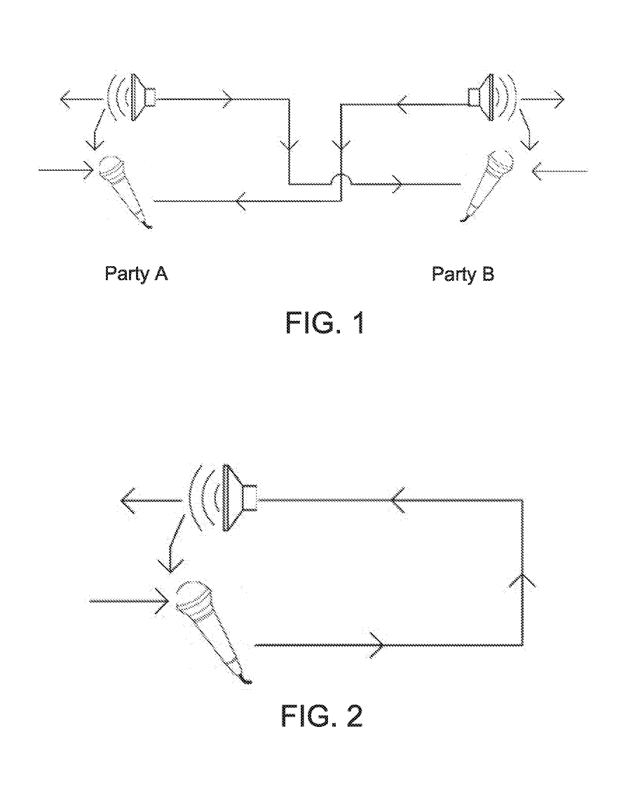

For example, referring to FIG. 1, when a party A and a party B conduct conversation using communication apparatuses, a microphone and a speaker at the party A are used to respectively collect the sound of the party A and play the sound of the party B, and a microphone and a speaker at the party B are used to respectively collect the sound of the party B and play the sound of the party A. It is apparent that, due to the sound propagation properties, the microphone at the party A at the same time collects the sound of the party B played by the speaker at the party A while the collecting the sound of the party A; that is, the sound collected at the party A is a mixed sound. When the mixed sound is transmitted to the party B through a network, the party B can hear the sound thereof of a few seconds earlier in addition to hearing the sound of the party A; that is, the party B hears echo thereof. Similarly, the party A also hears echo thereof at the party A.

Acoustic echo is not limited to only communication apparatuses. For example, referring to FIG. 2, a television having a microphone, such as a karaoke device frequently used in a home is a common type of entertainment tool in the daily lives. When a user uses a karaoke device for singing, the sound currently from a sound system is at the same time collected while the sound system plays the sound collected by the microphone. Thus, while the sound system plays the sound collected by the microphone, sound previously played is further again played in addition to playing the sound of the user, hence generating acoustic echo.

It should be noted that, when a return time of echo exceeds 10 ms, such echo can be apparently heard by the human ear and can interfere a normal call. For an Internet Protocol (IP) environment with a longer time delay, the time delay can easily reach as long has 50 ms, which severely affects perception and experience of both parties of the call. Therefore, echo needs to be eliminated.

As previously described in the section of the background of the prior art, to eliminate acoustic echo, an input device such as a microphone is additionally provided in the prior art to collect analog audio data already outputted from an output terminal of an electronic apparatus, or digital audio data to be immediately outputted is fed back to a sound input terminal through a lead wire provided. After the sound input terminal collects an external sound (which may include output audio data of a sound output terminal), the collected external sound is processed to eliminate the additionally collected audio data of the output terminal, so as to perform echo cancellation and eliminate acoustic echo.

However, in the method of the prior art, an additional hardware device needs to be provided. In particular, costs of an electronic apparatus are significantly increased if an audio collection device (e.g., a microphone) is added at an output terminal of the electronic apparatus. Moreover, when the collected sound of the sound output terminal is transmitted to an input terminal, an interface at the input terminal is necessarily occupied, which obviously limits the application of an electronic apparatus and affects subsequent function expansion and development.

Specific details are given in the description associated with the embodiments of the present invention below to fully understand the present invention. It should be noted that, the present invention can be implemented by various other methods that are not described herein, and a person skilled in the art can make similar modifications and arrangements without departing from the spirit of the present invention. Therefore, the present invention is not limited by the embodiments disclosed below.

In view of the issues of the prior art, the present invention provides an electronic apparatus and an echo cancellation method applied to the electronic apparatus. Details of the present invention are given in the embodiments with the accompanying drawings below.

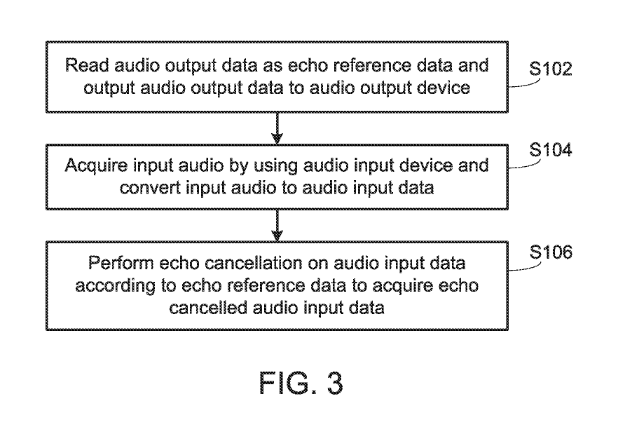

FIG. 3 shows a flowchart of an echo cancellation method applied to an electronic apparatus according to an embodiment of the present invention.

It should be noted that, echo cancellation in the embodiment of the present invention is primarily targeted at acoustic echo.

In the embodiment, the electronic apparatus may be a television having a microphone, a karaoke device frequently used in a home, or a smart terminal device having a call function, such as a cell phone, a phone, a tablet computer or a laptop computer.

In the embodiment, the electronic apparatus includes an audio input device and an audio output device. The audio input device is a device that receives analog audio data, and may be, for example, a microphone of a television or a smart terminal device; the audio output device is a device capable of playing digital audio data, and may be, for example, a speaker of a television or a smart terminal device.

Specifically, the echo cancellation method applied to an electronic device includes the following steps.

In step S102, audio output data is read to serve as echo reference data, and the audio output data is outputted to an audio output device.

The audio output data is audio data that needs to be outputted by the audio output device, and may be digital audio data obtained after processing analog audio data inputted through the audio input device by a user, or may be audio data obtained through any other arbitrary means, for example, audio data stored in an electronic apparatus. That is, the type of the audio output data is specifically defined herein.

It should be noted that, before the audio output data is outputted to the audio output device, the audio output data is read to a memory of the electronic apparatus to serve as echo reference data.

The echo reference data is used as reference data during echo cancellation, and the audio data corresponding to the echo reference data is deleted from the input audio data acquired by the audio input device.

Further, different from the prior art, when the echo reference data is acquired, firmware of a chip of the electronic apparatus is modified in this embodiment to read the audio output data to the memory of the electronic device to serve as the echo reference data before the audio output data is outputted to the audio output device. Thus, when echo cancellation is performed, the audio input device can directly read the echo reference data from the memory instead of requiring an additional hardware device for transmitting the echo reference signal to the input terminal of the audio input device.

In step S104, input audio is acquired using the audio input device, and the input audio is converted to audio input data.

It is understandable that, the input audio acquired by the input device can include a user sound in an analog form collected by the audio input device and a sound in an analog form played by the audio output device.

The audio input data is digital audio data obtained from performing analog-to-digital conversion on the input audio, or audio data obtained from further performing filtering and amplification by a filter and an amplifier.

In step S106, echo cancellation is performed on the audio input data according to the echo reference data to acquire echo cancelled audio input data.

The audio input data includes audio data corresponding to the audio outputted by the audio output device. Thus, when echo cancellation is performed, the audio data corresponding to the audio outputted by the audio output device needs to be eliminated from the audio input data. Specifically, because the corresponding audio data and the echo reference data are highly correlated, the echo reference signal is needed for echo cancellation.

Specifically, the echo reference data is merely correlated with the corresponding audio output data outputted from the audio output device and collected by the audio input device rather than being completely identical. More particularly, after influences of multiple operation processes such as the output of the audio output device, propagation in the environment (e.g., a sound reflected for a multiple times by a surface of a ceiling) and the input of the audio input device, the difference between the two can be quite large. Thus, when echo cancellation is performed at this point, if the echo reference data is simply subtracted from the audio, the difference between the finally obtained audio data and desired audio data can even be increased.

Therefore, in some application scenarios, when echo reference data is used for echo cancellation, the echo reference data needs to be processed to have the echo reference data be as similar to the corresponding part in the audio input data as much as possible, thereby cancelling echo as much as possible after echo cancellation is performed. Specifically, a predetermined algorithm can be used to process the echo cancellation data, and the predetermined algorithm may be obtained according to a joint design of the audio output device, the audio input device and environmental acoustic attributes. For example, a self-adjusting filter algorithm can be used to simulate the output of the audio output device, the input of the audio input device and environmental acoustic attributes before the audio output data is outputted to the audio output device, so as to estimate feature parameters of an echo path to generate a simulated echo path and to obtain a simulated echo signal. The simulated echo signal is then used as the echo reference data to perform echo cancellation on the audio input data.

Through the above method, when an electronic apparatus performs echo cancellation, audio output data can be read by means of software to a memory of the electronic apparatus to serve as echo reference data without requiring an additional hardware device or occupying an input interface of the electronic apparatus, thereby preventing negative influences on subsequent function expansion of the electronic apparatus as well as reducing echo cancellation costs.

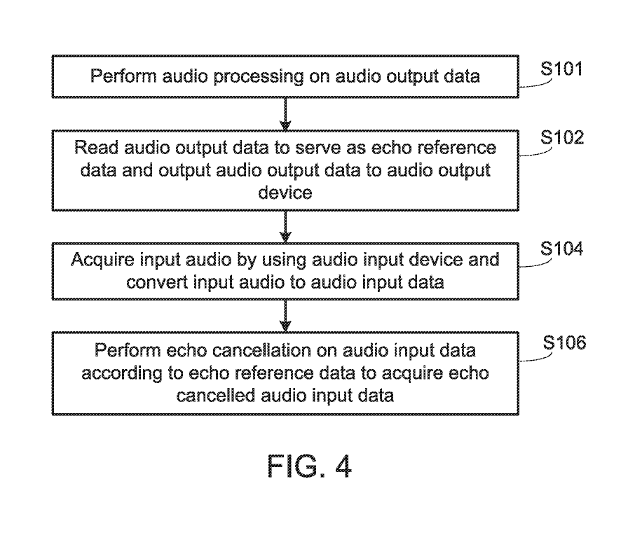

Referring to FIG. 4, in one embodiment, the echo cancellation method applied to an electronic apparatus further includes the following step before step S102.

In step S101, audio processing is performed on the audio output data.

In this embodiment, audio processing is performed on the audio output data before the audio output data is outputted to the audio output device, such that the sound outputted by the audio output device better meets requirements.

Specifically, the audio processing may include at least one of delay, sound effect processing, equalization, compression, limiting processing, and reverberation. Taking a television having a microphone as the electronic apparatus for example, assuming a user uses the television for singing, effects such as chorus or flanger can be generated after the audio output data has undergone delay processing and is then outputted by a speaker, such that the speaker can further output more enjoyable sounds to meet user requirements. The types of audio processing and the corresponding parameter configurations can be system-predetermined, or may be user-defined by a user according to user requirements.

It can be understood that, after the audio output data has undergone delay processing and/or sound effect processing, the processed audio output data is delayed audio output data, sound effect processed audio output data, or delayed and sound effect processed audio output data.

It should be noted that, the echo reference data read to the memory of the electronic apparatus may be original audio output data that has not undergone any audio processing, or may be processed audio output data having undergone audio processing.

In one embodiment, when the audio output data is read to the memory to serve as the echo reference data, a step of setting the volume of the read audio output data is further included.

When the volume of the read audio output data is set, the setting may be performed by using a system-predetermined volume, or may be performed according to the volume of the audio outputted by the audio output device and the volume of the audio inputted by the audio input device.

It should be noted that, when echo cancellation is performed, the echo cancellation effect gets better as the echo reference data is more similar to the corresponding part in the input audio data collected by the audio input device. Thus, before the audio output data is read to the memory to serve as the echo reference data, the volume of the read audio output data can be set, in a way that the read audio output data is consistent with the corresponding part in the input audio data acquired by the audio input device, thereby better eliminating the corresponding part.

In some application scenarios, the audio output device is adjusted to a mute mode, which outputs audio data with a zero volume. At this point, the audio input data does not collect any audio outputted by the audio output device; however, the echo reference data is still read to the memory. To prevent echo cancellation repeatedly performed from damaging the output effect of the audio, the volume of the read audio output data is set to mute, and the audio output data read to the memory is correspondingly reset to a null value; that is to say, no echo cancellation needs to be performed at this point.

With the embodiments above, in an echo cancellation method applied to an electronic apparatus of the present invention, through modification on firmware of a chip of the electronic device, audio output data is first read to a memory of the electronic apparatus to serve as echo reference data before the audio output data is outputted to an audio output device, so as to perform echo cancellation on audio input data at an audio input device according to the echo reference data. When echo reference data is collected in method according to the embodiments, no additional hardware device is required and an interface of an audio input device is not occupied, which is beneficial for both costs of the electronic apparatus or subsequent function expansion compared to the prior art.

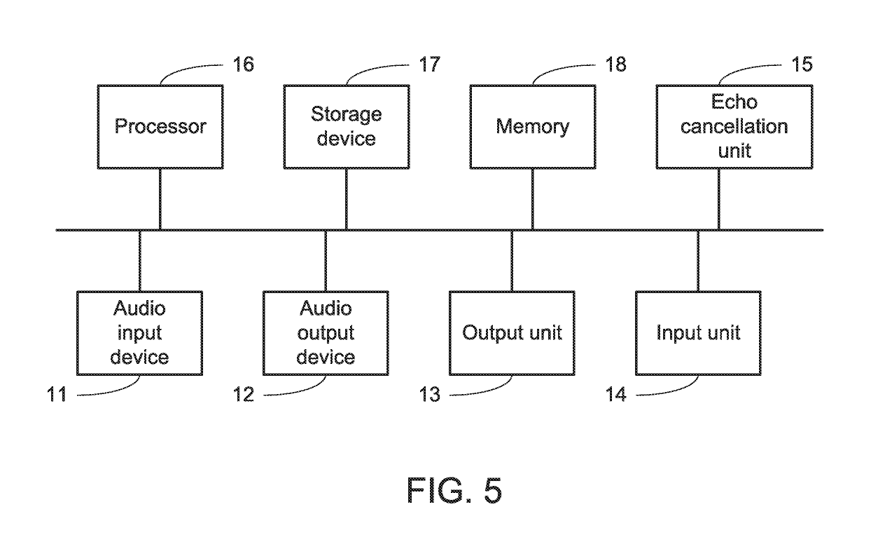

FIG. 5 shows a structural schematic diagram of an electronic apparatus according to an embodiment of the present invention. Similar to the electronic apparatus applied in the echo cancellation method applied to an electronic apparatus according to the above embodiments of the present invention, an electronic apparatus in this embodiment may be a television having a microphone, or a smart terminal device having a call function, such as a cell phone, a telephone, a tablet computer or a laptop computer.

Specifically, the electronic apparatus includes an audio input device 11, an audio output device 12, an output unit 13, an input unit 14, an echo cancellation unit 15, a processor 16, a storage device 17 and a memory 18.

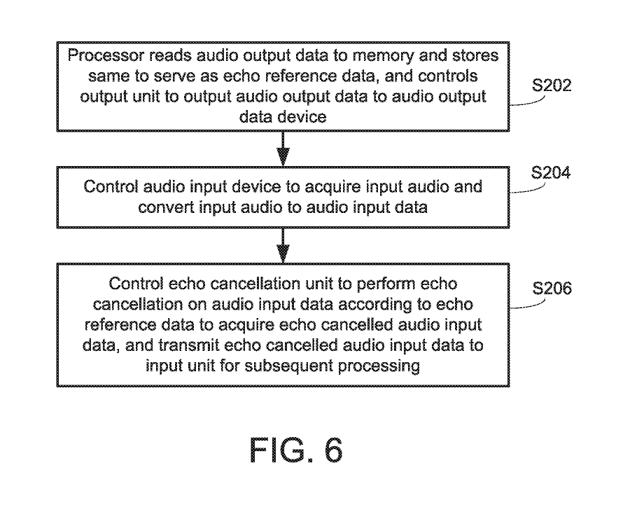

Referring to FIG. 6, the storage device 17 is stored with an echo cancellation program, and the processor 16 performs the following steps when the echo cancellation program is executed by the processor 16.

In step S202, the processor 16 reads audio output data to the memory 18, stores the audio output data to serve as echo reference data, and controls the output unit 13 to output the audio output data to the audio output device 12.

In step 240, the audio input device is controlled 11 to acquire input audio, and the input audio is converted to audio input data.

In step S206, the echo cancellation unit 15 is controlled to perform echo cancellation on the audio input data according to the echo reference data to acquire echo cancelled audio input data, and the echo cancelled audio input data is transmitted to the input unit 14 for subsequent processing.

The input unit 14 and the output unit 13 can respectively process the input audio data and the audio output data.

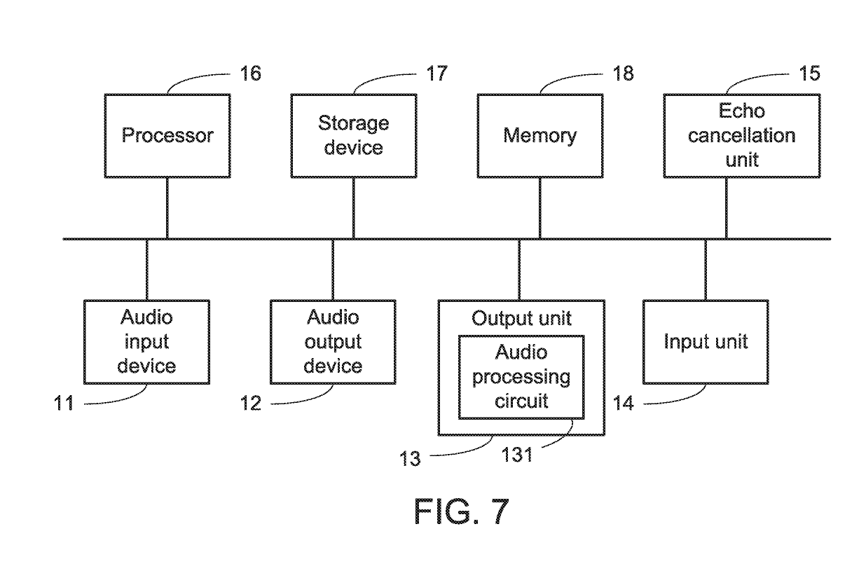

Specifically, referring to FIG. 7, the output unit 13 further includes an audio processing circuit 131.

Specifically, the audio processing circuit 131 performs audio processing on the audio output data before the audio output data is outputted to the audio output device 12.

The echo reference data read to the memory 18 is original audio output data that has not undergone any audio processing, or processed audio output data having undergone audio processing.

Specifically, details of the audio output device 12 and the audio input device 11 are similar to the description associated with the echo cancellation method applied to an electronic apparatus in the above embodiments of the present invention and can be referred from the above embodiments, and are thus omitted herein.

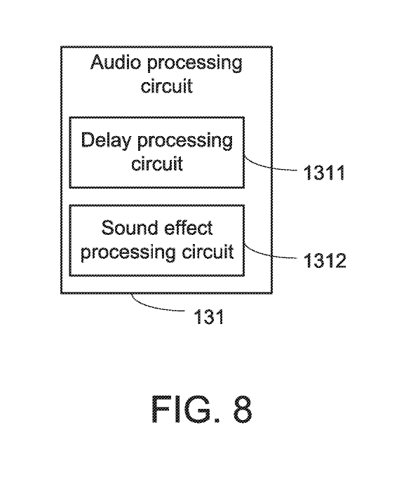

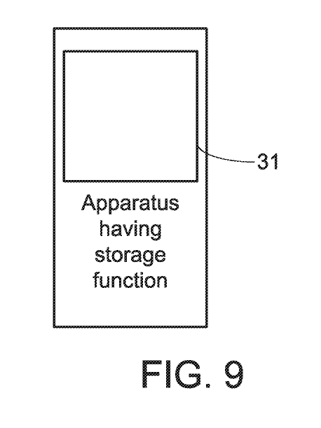

Referring to FIG. 8, in one embodiment, the audio processing circuit 131 further includes a delay processing circuit 1311 and/or a sound effect processing circuit 1312.

Specifically, the delay processing circuit 1311 is for performing delay processing on the audio output data, and the sound effect processing 1312 is for performing sound effect processing on the audio output data.

The processed audio output data having undergone audio processing is delayed audio output data or sound effect processed audio output data.

In one embodiment, when the processor 16 reads the audio output data to the memory 18 to serve as the echo reference data, the processor 16 further sets the volume of the audio output data according to the setting of the echo cancellation program.

When the volume of the read audio output data is set to mute, the processor 16 further resets the audio output data read to the memory 18 to a null value.

With the embodiments above, in an electronic apparatus of the present invention, through modification on firmware of a chip of the electronic device, audio output data is first read to the memory 18 of the electronic apparatus to serve as echo reference data before the audio output data is outputted to the audio output device 12, so as to perform echo cancellation on audio input data at the audio input device 11 according to the echo reference data. In the electronic apparatus according to the embodiments of the present invention, no additional hardware device is required and an interface of the audio input device is not occupied, which is beneficial for both costs of the electronic apparatus or subsequent function expansion compared to the prior art.

FIG. 9 shows a structural schematic diagram of an apparatus having a storage function according to an embodiment of the present invention. The apparatus having a storage function is stored with program data 31, which performs the steps of the echo cancellation method applied to an electronic apparatus according to the above embodiments of the present invention when executed by a processor. Associated details can be referred from the above description, and are omitted herein.

The apparatus having a storage function may be at least one of a server, a floppy disk drive, a hard drive, a CD-ROM reader, an optical disk reader, a CPU (for RAM).

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded with the broadest interpretation so as to encompass all such modifications and similar arrangements and procedures.

What is claimed is:

1. An echo cancellation method applied to an electronic apparatus, the electronic apparatus comprising an audio input device and an audio output device, the method comprising:
outputting audio output data to the audio output device, wherein the audio output data is read to a memory of the electronic apparatus to serve as echo reference data before being outputted to the audio output device;
acquiring input audio by using the audio input device, and converting the input audio to an audio input data; and
performing echo cancellation on the audio input data according to the echo reference data to acquire echo cancelled audio input data.

2. The method according to claim 1, before the step of outputting the audio output data to the audio output device, the method further comprising:
performing audio processing on audio output data;
wherein, the echo reference data read to the memory of the electronic apparatus is processed audio output data having undergone the audio processing.

3. The method according to claim 2, wherein the audio processing comprises delay processing and/or sound effect processing, and the processed audio output data having undergone the audio processing is delayed audio output data or sound effect processed audio output data.

4. The method according to claim 1, before the step of reading the audio output data to the memory to serve as the audio reference data, the method further comprising:
setting a volume of the read audio output data.

5. The method according to claim 4, wherein when the volume of the read audio output data is set, the audio output data read to the memory is reset to a null value.

6. The method according to claim 1, wherein the electronic apparatus is a television or a smart terminal device having a microphone, the microphone of the television or the smart terminal device serves as the audio input device and a speaker of the television or the smart terminal device serves as the audio output device.

7. An electronic apparatus, comprising an audio input device, an audio output device, an output unit, an input unit, an echo cancellation unit, a processor, a storage device and a memory; wherein, the storage device is stored with an echo cancellation program, and when the echo cancellation program is executed by the processor, the processor performs steps of:
controlling the output unit to output audio output data to the audio output device, wherein the processor reads the audio output data to the memory and stores the same to serve as echo reference data before the audio output data is outputted to the audio output device;
controlling the audio input device to acquire input audio, and converting the input audio to audio input data; and
controlling the echo cancellation unit to perform echo cancellation on the audio input data to acquire echo cancelled audio input data, and transmitting the echo cancelled audio input data to the input unit for subsequent processing.

8. The electronic apparatus according to claim 7, wherein the output unit comprises:
an audio processing circuit, performing audio processing on the audio output data before the audio output data is outputted to the audio output device;
wherein, the echo reference data read to the memory of the electronic apparatus is processed audio output data having undergone the audio processing.

9. The electronic apparatus according to claim 8, wherein the audio processing circuit further comprises:
a delay processing circuit, performing delay processing on the audio output data; and
a sound effect processing circuit, performing sound effect processing on the audio output data;
wherein, the processed audio output data having undergone the audio processing is delayed audio output data or sound effect processed audio output data.

10. The electronic apparatus according to claim 7, wherein when the processor reads the audio output data to the memory to serve as the echo reference data, the processor further sets a volume of the read audio output data according to a setting of the echo cancellation program.

11. The electronic apparatus according to claim 10, wherein when the volume of the read audio output data is set to mute, the processor further resets the audio output data read to the memory to a null value.

12. The electronic apparatus according to claim 7, being a television or a smart terminal device having a microphone, wherein the microphone of the television or the smart terminal device serves as the audio input device, and a speaker of the television or the smart terminal device serves as the audio output device.
